(19) United States
(12) Patent Application Publication
(10) Pub. No.: US 2013/0122150 A1
(43) Pub. Date: May 16, 2013

(54) Alkaline Antioxidant Mineral Water

(71) Applicant: Robert Kim, (US)

(72) Inventor: Robert Kim, (US)

(21) Appl. No.: 13/298,274

(22) Filed: Nov. 16, 2011

(51) Int. Cl. A23L 2/52; A23L 2/38

(52) U.S. Cl. 426/66

(57) ABSTRACT

An alkaline antioxidant mineral water comprises tripotassium phosphate and multiple healthful minerals in water, which is free of chlorine, fluoride, and heavy metals. The alkaline mineral water further includes organic potassium, calcium, zinc, magnesium, selenium and 79 trace minerals from ancient sea salt. The trace minerals are taken from the low-sodium technically-processed magnesium chloride marine deposits and chelated with amino acids. The amino acids are obtained from a non-animal source which is suitable for vegetarian and persons who are allergic to animal proteins. The alkaline antioxidant mineral water neutralizes and eliminates the excess acids in human body, thus improving blood circulation. In addition, it provides electrolytes and minerals, which are beneficial to human body.

### CROSS-REFERENCE TO RELATED APPLICATION

The present application constitutes a continuation in part of the following currently co-pending commonly owned United States patent application. The subject matter of the application listed below is incorporated by reference in their entirety in the present application to the extent such subject matter is not inconsistent herewith.

U.S. patent application Ser. No. 13/024,515, filed on Feb. 10, 2011, entitled “Alkaline Water,” naming Robert Kim as the inventor.

### BACKGROUND OF THE INVENTION

1. Field of the Invention

The present invention provides a composition of alkaline antioxidant mineral water for improving human health, comprising major essential and trace minerals in addition to antioxidants to human body. More specifically, the present invention relates to an alkaline (high pH) mineral drinking water that provides electrolytes and trace minerals required for daily life, and neutralizes the excess acids in human body, thus enhancing human health.

2. Description of Related Art

Water makes up 60 to 80% of the human body and is essential for life for several reasons: water is the most important universal medium to facilitate nutrient movement in the body. Water is essential in the process of electrical exchange on the level of neurotransmitters in the brain; water regulates our body temperature by evaporating sweat on the skin surface to alleviate excess body heat; water is lubricant in our digestive tract and in our joints; water is a solvent that flushed impurities from our system with the secretions of perspiration and urine. Therefore, the quality of drinking water is a very important factor for our health. The drinking water of high quality must be free of chlorine, fluoride, heavy metal and other harmful chemicals such as Dioxin or fertilizers; it should contain the electrolytes and minerals beneficial to human body; it should be alkaline with the pH 7.5 or higher.

For nearly a century, the alkaline water and electrolyte supplementation have been claimed to give certain health benefits. The scientific literature for electrolyte replacement and acid-base balance is voluminous, including Schwartz and Lyons, “Acid-Base and Electrolyte Balance—Normal Regulation and Clinical Disorders”, Grune & Stratton (1977); Carrol and Oh, “Water, Electrolyte and Acid—Base Metabolism”, Lippincott (1978); Kokko and Tannen, “Fluids and Electrolytes”, 2^{nd} Ed, W B Saunders Co. (1990) and others.

In 1996, Dr. Lynda Frassetto at the University of California, San Francisco discovered that as human ages, starting around age 45, human gradually loses the alkaline buffer capacity in the blood. Her findings were published in Journal of Gerontology: Biological Sciences, 1996, Vo. 51A, No. 1, B91-B99. Thus, to replenish alkaline buffer by intake of alkaline electrolytes is essential to human health as human gets older.

In addition to the evident support by mainstream scientific research archives of alkaline and electrolyte supplementation, the alternative medicine community advocates the supplementation of drinking water with alkaline additives. This includes Dr. Ted Baroody's “Alkalize or Die”, Holographic Health Inc, 8^{th} ed. (1991); Sang Whang's seminal book “Reverse Aging”, Jsp Publishing (1991); Dr. F. Batmanghelidj's “Your Body's Many Cries for Water”, Global Health Solutions; 2^{nd} ed. (1995); and Herman Aihara's “Acid and Alkaline” George Ohsawa Macrobiotic Foundation; 5^{th} ed. (1986).

The commercial interests of alkaline water and electrolyte supplementation has significantly increased in recent years. These trends result in the appearance of mutiple water ionizer machines such as Enagic (Los Angeles, Calif.) and Chanson (Laguna Hills, Calif.). These machines electrolyze the normal drinking water after a primary fitration and separate into an acidic portion which is disposed of or for other use and an alkaline portion which is consumed for better health. These machines are bulky, require electric power source, and are relatively expensive. Further examples of the commercial value are demonstrated by the increasing number of patents and commercial products of alkaline electrolyte-supplement water and beverages as well as tablets, capsules, and teas.

The U.S. Pat. No. 3,215,626 to Console describes a method of producing mineralized drinking water by adding potassium tri polyphosphate.

The U.S. Pat. No. 5,306,511 to Whang pertains to a concentrated additive solution that is added to normal drinking water to form an alkaline drinking water. Such water is of increased oxygen content with pH said to be in the range of 9 to 12. The concentrated additive solution is a combination of potassium hydroxide (KOH) and sodium hydroxide (NaOH).

The U.S. Pat. No. 5,849,346 to Hornack discloses a concentrated hydroxide solution, which is added to the acidic beverages such as coffee, tea, wine and other alcoholic beverages. The desired pH of beverages after addition of the concentrated hydroxide solution is about 7 to 11, preferably about 10 to 10.5.

The U.S. Pat. No. 6,572,902 to Abramowitz et al. discloses a process for producing alkaline drinking water and the product produced thereby. The alkaline water has a pH within the range of 9-10.

The U.S. Pat. No. 7,090,878 to Mehansho et al. discloses a water composition that is fortified with minerals and has a pH between about 2.5 and 9.5.

The U.S. Pat. No. 7,785,642 to Kaehne discloses mineral water compositions made of four different groups of elements. The pH is preferably adjusted to a final value of between 6.6 to 8.0 with a distilled water or a final value of between 2.5 to 8.0 for an aerated or carbonated water.

The PCT publication WO 99/21437 to Better Health Lab. Inc. discloses a source of alkaline (high pH) additive for dietary supplements, concentrated drops, tablets, capsules, bottle water, and beverages and related dietary supplement dosage forms.

As taken the mainstream scientific research interest, the support from the alternative medicine, the commercial development, and the attempts to satisfy these new trends into consideration, it should be expected that the existing practices and technologies still encounter challenges.
1. The central theme in the alternative medicine is the harmonious consumption of alkaline vegetables and beverages. However, the pH of the so-called alkaline vegetables are only pH 6 which is mildly acidic so that they are not really alkaline vegetables. The chance to drink naturally occurring alkaline water is very slim because these natural lye which is high pH alkaline springs isscarce around the world and very difficult to obtain. No nationwide water company is supplying this condition.
2. The machines that produce high pH water are expensive for people who live on a fixed income. Moreover, these bulky machines are impossible to carry by those who must travel.
3. Hydroxide drops as suggested in the U.S. Pat. No. 5,306,511 Whang, and U.S. Pat. No. 5,849,346 to Hornack are detrimental to skin, and eyes. Many people are scared to ingest a lye based product with sodium and potassium hydroxide orally in human electrolyte replacement.
4. Alkaline teas and tea bags are noteconomical to use regularly and are not readily available on a nationwide basis.
5. No nationally distributed products combining alkaline electrolytes added with regular vitamin-botanical dietary supplement has been commercialized.
6. Most of the examples in the aforementioned patents or commercial products still contain sodium which is not recommended by nutritionists, especially for persons with cardiovascular problems.

As one of the drawbacks, utilizing the concentrated additive drops to add to drinking water is to permit no control over the quality of drinking water that is used to dilute the concentrated additives. Most of tap water contains chlorine, fluoride, harmful chemicals such as fertilizers, heavy metals or sodium where hard water is processed to be soft water.

The invention described and claimed in the present application relates to an alkaline drinking water that is enriched with trace minerals from ancient sea salt and alkaline electrolytes, and has around pH 9. The present invention is distinct from other patents in that the present invention contains amino acids to chelate with trace minerals from the ancient sea salt. Moreover, the purified water used in this product is free of chlorine, fluoride, other harmful chemicals, heavy metals and sodium.

### SUMMARY OF THE INVENTION

The objective of the invention is to provide the composition of the low sodium alkaline antioxidant mineral water that has around pH 9 to neutralize acidic wastes in human body and remove excess free radicals.

Another objective is to create such an alkaline antioxidant mineral drinking water that is ready to drink and requires no power source or water to dilute it.

Still another objective is to introduce such an alkaline antioxidant mineral drinking water that offers up to 79 additional trace minerals including zinc and the antioxidant selenium.

Yet another objective is to create such an alkaline antioxidant mineral drinking water that offers non-animal sourced amino acids or protein hydrolysate to chelate trace minerals.

A further objective is such an alkaline antioxidant mineral drinking water that is free of chlorine, fluoride, other harmful chemicals, and heavy metals.

A further objective is such an alkaline antioxidant mineral drinking water that does not contain any preservatives.

The foregoing and other objects, features, and advantages of the present invention are accomplished in accordance with the claims of the present invention. One illustrative embodiment of which comprises an alkaline, ultra-low sodium drinking water of organic potassium salts and tripotassium phosphate.

As previously discussed, the objective of the invention is to provide an alkaline antioxidant mineral drinking water that has around pH 9. Among these ingredients, phosphorous is found in all cells and is involved in most biochemical reactions. It plays an important role in protein synthesis for the growth, maintenance, and repair of all tissues and cells. Because high amount of sodium is harmful to the human body, particularly to the patients with the cardiovascular complications. Tripotassium phosphate is selected as the major component in the prevent invention. Potassium is also an essential dietary mineral and electrolyte. Normal body function depends on tight regulation of potassium concentrations both inside and outside of cells. Potassium can stimulate kidney's function and stabilize heart rhythms.

The critical roles of calcium, magnesium, and potassium are known in the art. Human requires selenium for the function of a number of selenium-dependent enzymes, also known as selenoproteins. Selenium is an antioxidant that protects cell membranes and intra-cellular structural membranes from lipid peroxidation. Selenium deficiency has been associated with muscular weakness, impaired function of the immune system and others.

The alkaline antioxidant mineral drinking water does not contain preservative; it is free of chlorine, fluoride, other harmful chemicals, heavy metals and sodium.

The present invention claims the compositions of the alkaline antioxidant mineral drinking water which is considered nutritionally negligible in sodium content, provides electrolytes and minerals required for daily life, and neutralizes the excess acids in human body, thus balancing the electrolytes and pH inside the body and improving human health.

The more important features of the invention have thus been outlined in order that the more detailed description that follows may be better understood and in order that the present contribution to the art may better be appreciated. Additional features of the invention will be described hereinafter and will be proposed with the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE PREFERRED EMBODIMENT

The purpose of the invention is to provide low sodium antioxidant mineral drinking water that has preferably around pH 9. The antioxidant mineral drinking water is free of chlorine, fluoride, other harmful chemicals, and heavy metals. The drinking water is enriched with alkaline electrolytes, minerals and trace minerals. The alkaline drinking water is not intended to treat or cure any disease. It does, however, neutralize acids and enable the user or patient to achieve an alkaline lifestyle plus receiving benefits from electrolytes and minerals.

Initially deionized water is charged into a previously sanitized stainless steel steam jacketed vessel equipped with a propeller mixer. Alternatively, the deionized water may be heated to 80-90 degrees Celsius via a heat exchange unit.

Citric acid and a trace mineral as technically-processed marine sea salt concentrate are introduced along with a high proteolytic activity papain enzyme.

The alkaline antioxidant mineral drinking water further includes calcium, potassium, magnesium, and selenium and up to 79 trace minerals which include lithium, beryllium, boron, carbon, nitrogen, oxygen, fluorine, sodium, magnesium, aluminum, silicon, phosphorus, sulfur, chlorine, potassium, calcium, scandium, titanium, vanadium, chromium, manganese, iron, cobalt, nickel, copper, zinc, gallium, germanium, arsenic, selenium, bromine, berkelium, rubidium, strontium, yttrium, niobium, molybdenum, technetium, ruthenium, rhodium, palladium, silver, cadmium, indium, tin, antimony, tellurium, iodine, xenon, cesium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, bismuth, polonium, astatine, radon, barium, from ancient sea salt, especially from the technically-processed magnesium chloride marine deposits that are low in sodium. It's been recognized that the absorption and bioavailability of certain minerals or electrolytes by human body may be low.

As used herein, the term “free of” means “not existent of”, or “be absent of”.

The term “trace amount” means “trace would indicate the presence of a material in a sample, but in quantities approaching the limit of detection of the analytical method, and so too small to be accurately measured”.

It's also known in the art that the bioavailability of certain minerals or electrolytes can be increased if administered in the form of chelates wherein the chelating ligands are amino acids. Thus, the present application utilizes amino acids from a non-animal source (papain) to chelate with the minerals. The present invention is suitable for vegetarians or persons who are allergic to animal proteins. Papain is an enzyme, also known as papaya proteinase I, which is present in unripe papayas. It is used in cooking as a meat tenderizer; it can break down the tough meat fibers. In the present invention, it serves as the source of amino acids; once it is heated in acidic condition (citric acid in the formula), it decomposes to free amino acids, which can chelate with trace minerals.

As this mixture is slowly cooled, the hot papain enzyme is cleaved in the hot acidic environment and decomposed to free amino acids, which can chelate the trace minerals.

Slow mixing with slow cooling is continued until the mixture reaches about 50 degrees Celsius.

At this point an electrolyte mass up of saturated tripotassium phosphate is added and then organic potassium salts including potassium bicarbonate, potassium citrate, and potassium lactate 60% are added, Subsequently, pre-weighed amounts of magnesium chloride, zinc lactate, calcium chloride and selenium are added.

The slurry resulting therefrom is somewhat opaque and may require setting before final filtration. The product is cooled without mixing for 24 hours for complete coagulation of the non-soluble portions.

In the subsequent operation the product is decanted, running through a fine filter which is preferably 10-175 μm cartridge and packaged, or processed further. The product is now a clear liquid and can be dispensed in a bottle assembly.

The invention is further characterized by the tripotassium phosphate being in the 10-50% range of the total weight of the product, the organic potassium being in the 0.1-3% range, the minerals being in the 1-40 ppm range, the amino acids being in the 2-500 ppm range, the citric acids being in the 0.01-0.25% range and the papain enzymes being in the 2-500 ppm.

The above procedure is the most preferred embodiment of the invention. Moderate ranges occur around these percentages and procedures and are included in this patent.

The ranges above are the embodiment of the patent. The preferred range are about: 15-35% of tripotassium phosphate, 0.03-3% organic potassium salts, 3-25 ppm of trace minerals, 0.03-18% citric acid and 5-250 ppm high proteolytic papain enzyme. The cartridge range of pore dimension for preferred filtering efficiency would be 20-125 μm.

The most preferred embodiment of the patent would be about 30% of the tripotassium phosphate, 0.05-2% organic potassium salts, 5-15 ppm trace minerals, 0.05-10% citric acid, 20-40 ppm high proteolytic enzyme. The most preferred pore dimension of the filtration cartridge is 10-20 micron.

[symbol]

| Ingredient | % by weight |
|---|---|
| High proteolytic papain enzyme | 0.001 |
| Citric acid | 0.20 |
| Technically-processed magnesium | 0.10 |
| chloride (marine source) | |
| Tripotassium phosphate | 30 |
| Magnesium chloride | 0.03 |
| Selenium (Selenite) | 0.03 |
| Potassium bicarbonate | 6.00 |
| Zinc lactate | 0.05 |
| Potassium citrate | 0.10 |
| Calcium chloride | 0.05 |
| Potassium lactate 60% | 2.00 |
| Purified deionized water | qs |

### Example 2

Another suitable example of the invention in liquid form for human consumption, which is by no means exclusive, is as follows:

| Ingredient | % by weight |
|---|---|
| High proteolytic papain enzyme | 0.001 |
| Citric acid | 0.28 |
| Technically-processed magnesium | 0.10 |
| chloride (marine source) | |
| Tripotassium phosphate | 36 |
| Magnesium chloride | 0.03 |
| Selenium (Selenite) | 0.03 |
| Potassium bicarbonate | 5.00 |
| Zinc lactate | 0.04 |
| Potassium citrate | 0.10 |
| Calcium chloride | 0.04 |
| Potassium lactate 60% | 2.00 |
| Purified deionized water | qs |

No preservatives are added and the composition is stable in the absence of any preservatives.

Although this invention has been described in terms of a preferred embodiment, various changes and modifications can be made without departing from the intention and scope of the invention.

What is claimed is:

1. The alkaline antioxidant mineral water comprises tripotassium phosphate being from about 30 percent by weight in water, amino acids from papain, wherein said alkaline antioxidant mineral water is stable in the absence of preservatives.

2. The alkaline antioxidant mineral water of claim 1, wherein the water is free of chlorine.

3. The alkaline antioxidant mineral water of claim 1, wherein the water is free of fluoride.

4. The alkaline antioxidant mineral water of claim 1, wherein the water is free of heavy metals.

5. The alkaline antioxidant mineral water of claim 1 further comprises trace amount of calcium.

6. The alkaline antioxidant mineral water of claim further comprises trace amount of magnesium.

7. The alkaline antioxidant mineral water of claim 1 further comprises trace amount of zinc.

8. The alkaline antioxidant mineral water claim 1 further comprises trace amount of selenium.

9. The alkaline antioxidant mineral water claim 1 further comprises organic potassium salts including potassium carbonate, potassium citrate, and potassium lactate.

10. The alkaline antioxidant mineral water claim 1 further comprises citric acid.

11. The alkaline antioxidant mineral water of claim 1 further includes up to 79 trace minerals.

12. The alkaline antioxidant mineral water of claim 11 further comprises amino acids from non-animal sources.

13. The alkaline antioxidant mineral water of claim 12, wherein the trace minerals are chelated with free amino acids.

14. The alkaline antioxidant mineral water comprises tripotassium phosphate, organic potassium salts, trace minerals, citric acid, amino acids, and trace amount of magnesium, zinc, selenium, calcium, and water; the trace minerals are chelated with amino acids; the water is free of chlorine, fluoride and heavy metals.

15. The additive of claim 14, wherein the amino acids are derived from non-animal peptides or proteins.

16. The additive of claim 15, wherein the trace minerals are selected from low sodium technical magnesium chloride marine deposits.

17. The method for producing an alkaline antioxidant mineral water comprising tripotassium phosphate, organic potassium salts, trace minerals, citric acid, amino acids, and trace amount of magnesium, zinc, selenium, calcium and water; the trace minerals are chelated with amino acids; the water is free of chlorine, fluoride and heavy metals.

18. The additive of claim 14, wherein the preferred range are about 15-35% tripotassium phosphate, 0.03-3% organic potassium salts, 3-35 ppm trace minerals, 0.03-18% citric acid, 5-250 ppm of amino acids derived from 5-250 ppm high proteolytic enzyme, and trace amount of magnesium, zinc, selenium, calcium; all the units are weight by weight.

19. The additive of claim 14, wherein the preferred range are about 30% of tripotassium phosphate, 0.05-2% organic potassium salts, 5-15 ppm trace minerals, 0.05-10% citric acid, 20-40 ppm of amino acids derived from 20-40 ppm high proteolytic enzyme, and trace amount of magnesium, zinc, selenium, calcium; all the units are weight by weight.

20. A method of preparing alkaline antioxidant mineral water of claim 1, comprising the steps of:
(i) fill deionized water into a previously sanitized stainless steel steam jacketed vessel equipped with a propeller mixer;
(ii) heat said deionized water to 80-90 degrees Celsius via a heat exchange unit;
add and mix 0/03-18% citric acid and 3-35 PPM trace minerals;
add and mix a high proteolytic activity 0.001% papain enzyme;
(v) cool down the mixture from step (iv) to about 50 degrees Celsius;
add saturated 15-35% tripotassium phosphate and 0.03-3% organic potassium salts selected from the group consisting of 5-10% potassium bicarbonate, 0.1-0.3% potassium citrate, and 2.00-4.00% potassium lactate;
(vii) add pre-weighed amounts of 0.03%-0.06% magnesium chloride, 0.05-0.08% zinc lactate, 0.05-0.08%© calcium chloride and 0.03-0.05% selenium to form a slurry;
filtrate the mixture from step (vii) to obtain an aqueous solution;
cool down said aqueous solution from step (viii) without mixing for up to 24 hours; and
decant and run through a 10-175 μm cartridge to obtain said preservative free and stable alkaline antioxidant mineral water.
